(19) United States
(12) Patent Application Publication
(10) Pub. No.: US 2011/0304706 A1
(43) Pub. Date: Dec. 15, 2011

(54) VIDEO CAMERA PROVIDING VIDEOS WITH PERCEIVED DEPTH

(76) Inventors: John N. Border, Walworth, NY (US); Amit Singhal, Pittsford, NY (US)

(21) Appl. No.: 12/796,892

(22) Filed: Jun. 9, 2010

(51) Int. Cl. H04N 13/02

(52) U.S. Cl. 348/50; 348/E13.074

(57) ABSTRACT

A video image capture device for providing a video with perceived depth comprising: an image sensor for capturing video frames; an optical system for imaging a scene onto the image sensor from a single perspective; a data storage system for storing a sequence of video images captured by the image sensor; a position sensing device for sensing a relative position of the image capture device; a means for storing the sensed relative position of the image capture device in association with stored sequences of video images; a data processor; a memory system storing instructions configured to cause the data processor to provide a video with perceived depth. The video with perceived depth is provided by: selecting stereo pairs of video images responsive to the stored relative position of the image capture device.

### CROSS REFERENCE TO RELATED APPLICATIONS

Reference is made to commonly assigned, co-pending U.S. patent application Ser. No. ______ (docket 96132), entitled: “Forming video with perceived depth”, by Border et al., which is incorporated herein by reference.

### FIELD OF THE INVENTION

The invention pertains to a method for providing a video with perceived depth from a video captured using a single perspective image capture device.

### BACKGROUND OF THE INVENTION

Stereoscopic images of a scene are generally produced by combining two or more images that have different perspectives of the same scene. Typically stereoscopic images are captured simultaneously with an image capture device that has two (or more) image capture devices that are separated by a distance to provide different perspectives of the scene. However, this approach to stereo image capture requires a more complex image capture system having two (or more) image capture devices.

Methods for producing stereoscopic videos have been proposed wherein a single image capture device is used to capture a video comprising a time sequence of video image and then the video is modified to produce a video with perceived depth. In U.S. Pat. No. 2,865,988, to N. Cafarell, Jr., entitled “Quasi-stereoscopic systems,” a method is disclosed wherein a video is provided with perceived depth from a video that was captured with a single perspective image capture device. The video with perceived depth is produced by showing video images to the left and right eye of a viewer where timing of the video images shown to the left eye and right eye differ by a constant frame offset so that one eye receives the video images earlier in the time sequence than the other eye. Since the position of the camera and the positions of objects within the scene generally vary with time, the difference in temporal perception is interpreted by the viewer's brain as depth. However, because the amount of motion of the image capture device and the objects in the scene generally varies with time, the perception of depth is often inconsistent.

U.S. Pat. No. 5,701,154 to Dasso, entitled “Electronic three-dimensional viewing system,” also provides a video with perceived depth from a video captured with a single perspective image capture device. The video with perceived depth is produced by providing the video to the left and right eyes of the viewer with a constant frame offset (e.g., one to five frames) between the video presented to the left and right eyes of the viewer. In this patent, the video images presented to the left and right eyes can also be different in that the video images presented to one eye can be shifted in location, enlarged or brightened compared to the video images presented to the other eye to further enhance the perceived depth. However, with a constant frame offset the perception of depth will again be inconsistent due to the varying motion present during the capture of the video.

In U.S. Patent Application Publication 2005/0168485 to Nattress, entitled “System for combining a sequence of images with computer-generated 3D graphics,” a system is described for combining a sequence of images with computer generated three dimensional animations. The method of this patent application includes the measurement of the location of the image capture device when capturing each image in the sequence to make it easier to identify the perspective of the image capture device and thereby make it easier to combine the captured images with the computer generated images in the animation.

A method for post-capture conversion of videos captured with a single perspective image capture device to a video with perceived depth is disclosed in U.S. Patent Application Publication 2008/0085049 to Naske et al., entitled “Methods and systems for 2D/3D image conversion and optimization.” In this method, sequential video images are compared with each other to determine the direction and rate of motion in the scene. A second video is generated which has a frame offset compared to the captured video wherein the frame offset is reduced to avoid artifacts when rapid motion or vertical motion is detected in the comparison of the sequential video images with each other. However, the amount of motion of the camera and objects in the scene will still vary with time, and therefore the perception of depth will still be inconsistent and will vary with the motion present during capture of the video.

In U.S. Patent Application Publication 2009/0003654, measured locations of an image capture device are used to determine range maps from pairs of images that have been captured with an image capture device in different locations.

There remains a need for providing videos with perceived depth from videos captured with a single perspective image capture device, wherein the video with perceived depth has improved image quality and an improved perception of depth when there is inconsistent motion of the image capture device or objects in the scene.

### SUMMARY OF THE INVENTION

The present invention represents a video image capture device for providing a video with perceived depth comprising:

an image sensor for capturing video frames;

an optical system for imaging a scene onto the image sensor from a single perspective;

a data storage system for storing a sequence of video images captured by the image sensor;

a position sensing device for sensing a relative position of the image capture device for the sequence of video images;

a means for storing an indication of the sensed relative position of the image capture device on the data storage system in association with stored sequences of video images;

a data processor;

a memory system communicatively connected to the data processor and storing instructions configured to cause the data processor to provide a video with perceived depth by:
selecting stereo pairs of video images responsive to the stored relative position of the image capture device; and
providing a video with perceived depth including a sequence of the stereo pairs of video images.

The present invention has the advantage that video images with perceived depth can be provided using video images of a scene captured with a single perspective image capture device. The videos with perceived depth are formed responsive to a relative position of the image capture device in order to provide a more consistent sensation of perceived depth.

It has the further advantage that images with no perceived depth can be provided when motion of the image capture device is detected which is inconsistent with producing video images having perceived depth.

### BRIEF DESCRIPTION OF THE DRAWINGS

Embodiments of the invention are better understood with reference to the following drawings.

FIG. 1 is a block diagram of a video image capture device;

FIG. 2A is an illustration of a video image capture device with three objects in the field of view;

FIG. 2B is an illustration of an image that would be captured with the video image capture device from FIG. 2A;

FIG. 3A is an illustration of the video image capture device of FIG. 2A wherein the field of view has been changed by shifting the video image capture device laterally;

FIG. 3B is an illustration of an image that would be captured with the video image capture device from FIG. 3A;

FIG. 4A is an illustration of the video image capture device of FIG. 2A wherein the field of view has been changed by rotating the video image capture device;

FIG. 4B is an illustration of an image that would be captured with the video image capture device from FIG. 4A;

FIG. 5A is an illustration of overlaid images from FIG. 2B and FIG. 3B showing the stereo mismatch of the images;

FIG. 5B is an illustration of overlaid images from FIG. 2B and FIG. 4B showing the stereo mismatch of the images;

FIG. 6A is a flowchart of a method for forming a video with perceived depth according to one embodiment of the invention;

FIG. 6B is a flowchart of a method for forming a video with perceived depth according to a further embodiment of the invention;

FIG. 7 is an illustration of a removable memory card having a built-in motion tracking device;

FIG. 8 is a block diagram of a removable memory card with built-in motion tracking devices that includes the components needed to form video images with perceived depth inside the card removable memory card; and

FIG. 9 is a schematic diagram of a sequence of video frames subjected to MPEG encoding.

### DETAILED DESCRIPTION OF THE INVENTION

Producing images with perceived depth requires two or more images with different perspectives to be presented in a way that the viewer's left and right eyes view different perspective images. For the simplest case of stereo images, two images with different perspectives are presented to a viewer in the form of a stereo pair, where the stereo pair is comprised of an image for the left eye of the viewer and an image for the right eye of the viewer. A video with perceived depth is comprised of a series of stereo pairs that are presented sequentially to the viewer.

The present invention provides a method for producing a video with perceived depth from a video captured using a video image capture device that has only a single perspective. Typically, the single perspective is provided by a video image capture device with one electronic image capture unit comprised of one lens and one image sensor. However, the invention is equally applicable to a video image capture device that has more than one electronic image capture unit, more than one lens or more than one image sensor provided that only one electronic image capture unit or only one lens and one image sensor are used to capture a video at a time.

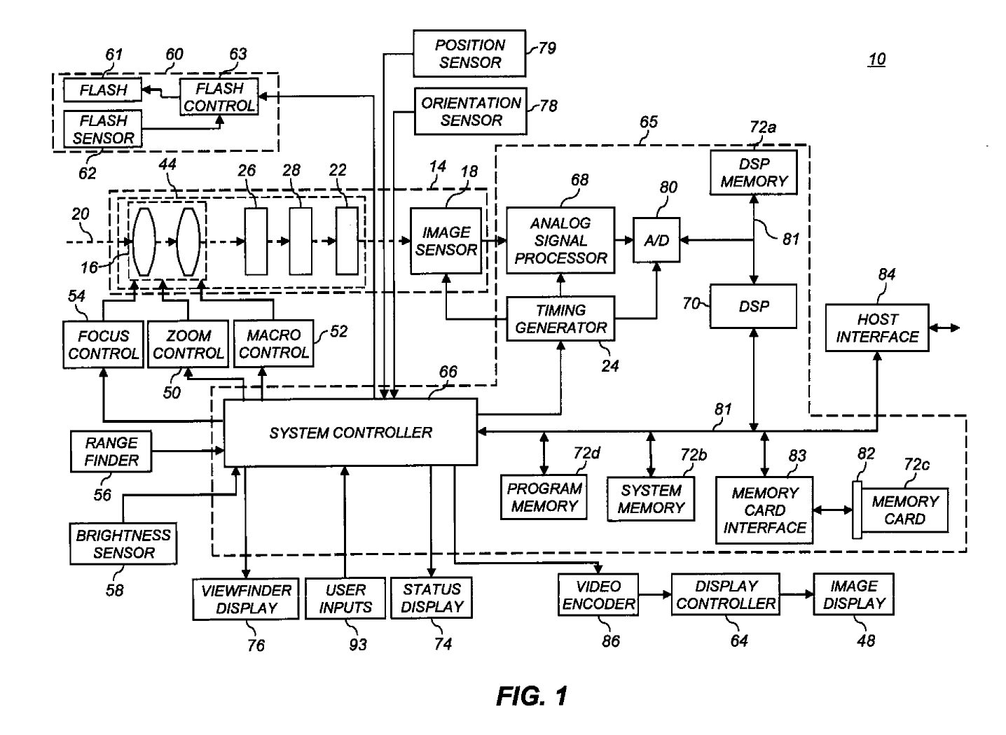

Referring to FIG. 1, in a particular embodiment, the components of a video image capture device 10 are shown wherein the components are arranged in a body that provides structural support and protection. The body can be varied to meet requirements of a particular use and style considerations. An electronic image capture unit 14, which is mounted in the body of the video image capture device 10, has at least a taking lens 16 and an image sensor 18 aligned with the taking lens 16. Light from a scene propagates along an optical path 20 through the taking lens 16 and strikes the image sensor 18 producing an analog electronic image.

The type of image sensor used can vary, but in a preferred embodiment, the image sensor is a solid-state image sensor. For example, the image sensor can be a charge-coupled device (CCD), a CMOS sensor (CMOS), or charge injection device (CID). Generally, the electronic image capture unit 14 will also include other components associated with the image sensor 18. A typical image sensor 18 is accompanied by separate components that act as clock drivers (also referred to herein as a timing generator), analog signal processor (ASP) and analog-to-digital converter/amplifier (A/D converter). Such components are often incorporated into a single unit together with the image sensor 18. For example, CMOS image sensors are manufactured with a process that allows other components to be integrated onto the same semiconductor die.

Typically, the electronic image capture unit 14 captures an image with three or more color channels. It is currently preferred that a single image sensor 18 be used along with a color filter array, however, multiple image sensors and different types of filters can also be used. Suitable filters are well known to those of skill in the art, and, in some cases are incorporated with the image sensor 18 to provide an integral component.

The electrical signal from each pixel of the image sensor 18 is related to both the intensity of the light reaching the pixel and the length of time the pixel is allowed to accumulate or integrate the signal from incoming light. This time is called the integration time or exposure time.

Integration time is controlled by a shutter 22 that is switchable between an open state and a closed state. The shutter 22 can be mechanical, electromechanical or can be provided as a logical function of the hardware and software of the electronic image capture unit 14. For example, some types of image sensors 18 allow the integration time to be controlled electronically by resetting the image sensor 18 and then reading out the image sensor 18 some time later. When using a CCD image sensor, electronic control of the integration time can be provided by shifting the accumulated charge under a light shielded register provided in a non-photosensitive region. This light shielded register can be for all the pixels as in a frame transfer device CCD or can be in the form of rows or columns between pixel rows or columns as in an interline transfer device CCD. Suitable devices and procedures are well known to those of skill in the art. Thus, a timing generator 24 can provide a way to control when the integration time occurs for the pixels on the image sensor 18 to capture the image. In the video image capture device 10 of FIG. 1, the shutter 22 and the timing generator 24 jointly determine the integration time.

The combination of overall light intensity and integration time is called exposure. Exposure combined with the sensitivity and noise characteristics of the image sensor 18 determine the signal-to-noise ratio provided in a captured image. Equivalent exposures can be achieved by various combinations of light intensity and integration time. Although the exposures are equivalent, a particular exposure combination of light intensity and integration time can be preferred over other equivalent exposures for capturing an image of a scene based on the characteristics of the scene or the associated signal-to-noise ratio.

Although FIG. 1 shows several exposure controlling elements, some embodiments may not include one or more of these elements, or there can be alternative mechanisms for controlling exposure. The video image capture device 10 can have alternative features to those illustrated. For example, shutters that also function as diaphragms are well-known to those of skill in the art.

In the illustrated video image capture device 10, a filter assembly 26 and aperture 28 modify the light intensity at the image sensor 18. Each can be adjustable. The aperture 28 controls the intensity of light reaching the image sensor 18 using a mechanical diaphragm or adjustable aperture (not shown) to block light in the optical path 20. The size of the aperture can be continuously adjustable, stepped, or otherwise varied. As an alternative, the aperture 28 can be moved into and out of the optical path 20. Filter assembly 26 can be varied likewise. For example, filter assembly 26 can include a set of different neutral density filters that can be rotated or otherwise moved into the optical path. Other suitable filter assemblies and apertures are well known to those of skill in the art.

The video image capture device 10 has an optical system 44 that includes the taking lens 16 and can also include components (not shown) of a viewfinder to help the operator compose the image to be captured. The optical system 44 can take many different forms. For example, the taking lens 16 can be fully separate from an optical viewfinder or can include a digital viewfinder that has an eyepiece provided over an internal display where preview images are continuously shown prior to and after image capture. Wherein, preview images are typically lower resolution images that are captured continuously. The viewfinder lens unit and taking lens 16 can also share one or more components. Details of these and other alternative optical systems are well known to those of skill in the art. For convenience, the optical system 44 is generally discussed hereafter in relation to an embodiment having an on-camera digital viewfinder display 76 or an image display 48 that can be used to view preview images of a scene, as is commonly done to compose an image before capture with an image capture device such as a digital video camera.

The taking lens 16 can be simple, such as having a single focal length and manual focusing or a fixed focus, but this is not preferred. In the video image capture device 10 shown in FIG. 1, the taking lens 16 is a motorized zoom lens in which a lens element or multiple lens elements are driven, relative to other lens elements, by a zoom control 50. This allows the effective focal length of the lens to be changed. Digital zooming (digital enlargement of a digital image) can also be used instead of or in combination with optical zooming. The taking lens 16 can also include lens elements or lens groups (not shown) that can be inserted or removed from the optical path, by a macro control 52 so as to provide a macro (close focus) capability.

The taking lens 16 of the video image capture device 10 can also be autofocusing. For example, an autofocusing system can provide focusing passive or active autofocus or a combination of the two. Referring to FIG. 1, one of more focus elements (not separately shown) of the taking lens 16 are driven, by a focus control 54 to focus light from a particular distance in the scene onto the image sensor 18. The autofocusing system can operate by capturing preview images with different lens focus settings or the autofocus system can have a rangefinder 56 that has one or more sensing elements that send a signal to a system controller 66 that is related to the distance from the video image capture device 10 to the scene. The system controller 66 does a focus analysis of the preview images or the signal from the rangefinder and then operates focus control 54 to move the focusable lens element or elements (not separately illustrated) of the taking lens 16. Autofocusing methods are well known in the art.

The video image capture device 10 includes a means to measure the brightness of the scene. The brightness measurement can be done by analyzing the pixel code values in preview images or through the use of a brightness sensor 58. In FIG. 1, brightness sensor 58 is shown as one or more separate components. The brightness sensor 58 can also be provided as a logical function of hardware and software of the electronic image capture unit 14. The brightness sensor 58 can be used to provide one or more signals representing light intensity of the scene for use in the selection of exposure settings for the one or more image sensors 18. As an option, the signal from the brightness sensor 58 can also provide color balance information. An example, of a suitable brightness sensor 58 that can be used to provide one or both of scene illumination and color value and is separate from the electronic image capture unit 14, is disclosed in U.S. Pat. No. 4,887,121.

The exposure can be determined by an autoexposure control. The autoexposure control can be implemented within the system controller 66 and can be selected from those known in the art, an example of which is disclosed in U.S. Pat. No. 5,335,041. Based on brightness measurements of a scene to be imaged, either as provided by a brightness sensor 58 or as provided by measurements from pixel values in preview images, the electronic imaging system typically employs autoexposure control processing to determine an effective exposure time, tₑ, that will yield an image with effective brightness and good signal to noise ratio. In the present invention, the exposure time, tₑ, determined by the autoexposure control is used for capture of the preview images and then may be modified for the capture of an archival image capture based on scene brightness and anticipated motion blur, where the archival image is the final image that is captured after the capture conditions (including exposure time) have been defined based on the method of the invention. One skilled in the art will recognize that the shorter the exposure time, the less motion blur and more noise will be present in the archival image.

The video image capture device 10 of FIG. 1 optionally includes a flash unit 60, which has an electronically controlled flash 61 (such as a xenon flash tube or an LED). Generally, the flash unit 60 will only be employed when the video image capture device 10 is used to capture still images. A flash sensor 62 can optionally be provided, which outputs a signal responsive to the light sensed from the scene during archival image capture or by way of a preflash prior to archival image capture. The flash sensor signal is used in controlling the output of the flash unit by a dedicated flash control 63 or as a function of a control unit 65. Alternatively, flash output can be fixed or varied based upon other information, such as focus distance. The function of flash sensor 62 and brightness sensor 58 can be combined in a single component or logical function of the capture unit and control unit.

The image sensor 18 receives an image of the scene as provided by the taking lens 16 and converts the image to an analog electronic image. The electronic image sensor 18 is operated by an image sensor driver. The image sensor 18 can be operated in a variety of capture modes including various binning arrangements. The binning arrangement determines whether pixels are used to collect photo-electrically generated charge individually, thereby operating at full resolution during capture, or electrically connected together with adjacent pixels thereby operating at a lower resolution during capture. The binning ratio describes the number of pixels that are electrically connected together during capture. A higher binning ratio indicates more pixels are electrically connected together during capture to correspondingly increase the sensitivity of the binned pixels and decrease the resolution of the image sensor. Typical binning ratios include 2×, 3×, 6× and 9× for example. The distribution of the adjacent pixels that are binned together in a binning pattern can vary as well. Typically adjacent pixels of like colors are binned together to keep the color information consistent as provided by the image sensor. The invention can be equally applied to image capture devices with other types of binning patterns.

The control unit 65 controls or adjusts the exposure regulating elements and other camera components, facilitates transfer of images and other signals, and performs processing related to the images. The control unit 65 shown in FIG. 1 includes the system controller 66, the timing generator 24, an analog signal processor 68, an analog-to-digital (A/D) converter 80, a digital signal processor 70, and various memories (DSP memory 72a, system memory 72b, memory card 72c (together with memory card interface 83 and socket 82) and program memory 72d). Suitable components for elements of the control unit 65 are known to those of skill in the art. These components can be provided as enumerated or by a single physical device or by a larger number of separate components. The system controller 66 can take the form of an appropriately configured microcomputer, such as an embedded microprocessor having RAM for data manipulation and general program execution. Modifications of the control unit 65 are practical, such as those described elsewhere herein.

The timing generator 24 supplies control signals for all electronic components in a timing relationship. Calibration values for the individual video image capture device 10 are stored in a calibration memory (not separately illustrated), such as an EEPROM, and supplied to the system controller 66. Components of a user interface (discussed below) are connected to the control unit 65 and function by using a combination of software programs executed on the system controller 66. The control unit 65 also operates the various controls and associated drivers and memories, including the zoom control 50, focus control 54, macro control 52, display controller 64 and other controls (not shown) for the shutter 22, aperture 28, filter assembly 26, viewfinder display 76 and status display 74.

The video image capture device 10 can include other components to provide information supplemental to captured image information or pre-capture information. Examples of such supplemental information components are the orientation sensor 78 and the position sensor 79 illustrated in FIG. 1. The orientation sensor 78 can be used to sense whether the video image capture device 10 is oriented in a landscape mode or a portrait mode. The position sensor 79 can be used to sense a position of the video image capture device 10. For example, the position sensor 79 can include one or more accelerometers for sensing movement in the position of the camera. Alternately, the position sensor 79 can be a GPS receiver which receives signals from global positioning system satellites to determine an absolute geographical location. Other examples of components to provide supplemental information include a real time clock, inertial position measurement sensors, and a data entry device (such as a keypad or a touch screen) for entry of user captions or other information.

It will be understood that the circuits shown and described can be modified in a variety of ways well known to those of skill in the art. It will also be understood that the various features described here in terms of physical circuits can be alternatively provided as firmware or software functions or a combination of the two. Likewise, components illustrated as separate units herein can be conveniently combined or shared. Multiple components can be provided in distributed locations.

The initial electronic image from the image sensor 18 is amplified and converted from analog to digital by the analog signal processor 68 and A/D converter 80 to a digital electronic image, which is then processed in the digital signal processor 70 using DSP memory 72a and stored in system memory 72b or removable memory card 72c. Signal lines, illustrated as a data bus 81, electronically connect the image sensor 18, system controller 66, digital signal processor 70, the image display 48, and other electronic components; and provide a pathway for address and data signals.

“Memory” refers to one or more suitably sized logical units of physical memory provided in semiconductor memory or magnetic memory, or the like. DSP memory 72a, system memory 72b, memory card 72c and program memory 72d can each be any type of random access memory. For example, memory can be an internal memory, such as a Flash EPROM memory, or alternately a removable memory, such as a Compact Flash card, or a combination of both. Removable memory card 72c can be provided for archival image storage. Removable memory card 72c can be of any type, such as a Compact Flash (CF) or Secure Digital (SD) type card inserted into the socket 82 and connected to the system controller 66 via the memory card interface 83. Other types of storage that are utilized include without limitation PC-Cards or MultiMedia Cards (MMC).

The control unit 65, system controller 66 and digital signal processor 70 can be controlled by software stored in the same physical memory that is used for image storage, but it is preferred that the control unit 65, digital signal processor 70 and system controller 66 are controlled by firmware stored in dedicated program memory 72d, for example, in a ROM or EPROM firmware memory. Separate dedicated units of memory can also be provided to support other functions. The memory on which captured images are stored can be fixed in the video image capture device 10 or removable or a combination of both. The type of memory used and the manner of information storage, such as optical or magnetic or electronic, is not critical to the function of the present invention. For example, removable memory can be a floppy disc, a CD, a DVD, a tape cassette, or flash memory card or a memory stick. The removable memory can be utilized for transfer of image records to and from the video image capture device 10 in digital form or those image records can be transmitted as electronic signals, for example over an interface cable or a wireless connection.

Digital signal processor 70 is one of two processors or controllers in this embodiment, in addition to system controller 66. Although this partitioning of camera functional control among multiple controllers and processors is typical, these controllers or processors can be combined in various ways without affecting the functional operation of the camera and the application of the present invention. These controllers or processors can comprise one or more digital signal processor devices, microcontrollers, programmable logic devices, or other digital logic circuits. Although a combination of such controllers or processors has been described, it should be apparent that one controller or processor can perform all of the needed functions. All of these variations can perform the same function.

In the illustrated embodiment, the control unit 65 and the digital signal processor 70 manipulate the digital image data in the DSP memory 72a according to a software program permanently stored in program memory 72d and copied to system memory 72b for execution during image capture. Control unit 65 and digital signal processor 70 execute the software necessary for practicing image processing. The digital image can also be modified in the same manner as in other image capture devices such as digital cameras to enhance digital images. For example, the digital image can be processed by the digital signal processor 70 to provide interpolation and edge enhancement. Digital processing of an electronic archival image can include modifications related to file transfer, such as, JPEG compression, and file formatting. Metadata can also be provided with the digital image data in a manner well known to those of skill in the art.

System controller 66 controls the overall operation of the image capture device based on a software program stored in program memory 72d, which can include Flash EEPROM or other nonvolatile memory. This memory can also be used to store calibration data, user setting selections and other data which must be preserved when the image capture device is turned off. System controller 66 controls the sequence of image capture by directing the macro control 52, flash control 63, focus control 54, zoom control 50, and other drivers of capture unit components as previously described, directing the timing generator 24 to operate the image sensor 18 and associated elements, and directing the control unit 65 and the digital signal processor 70 to process the captured image data. After an image is captured and processed, the final image file stored in system memory 72b or DSP memory 72a, is transferred to a host computer via host interface 84, stored on a removable memory card 72c or other storage device, and displayed for the user on image display 48. Host interface 84 provides a high-speed connection to a personal computer or other host computer for transfer of image data for display, storage, manipulation or printing. This interface can be an IEEE1394 or USB2.0 serial interface or any other suitable digital interface. The transfer of images, in the method, in digital form can be on physical media or as a transmitted electronic signal.

In the illustrated video image capture device 10, processed images are copied to a display buffer in system memory 72b and continuously read out via video encoder 86 to produce a video signal for the preview images. This signal is processed by display controller 64 or digital signal processor 70 and presented on an on-camera image display 48 as the preview images or can be output directly from the video image capture device 10 for display on an external monitor. The video images are archival if the video image capture device 10 is used for video capture and non-archival if used as the preview images for viewfinding or image composing prior to still archival image capture.

The video image capture device 10 has a user interface, which provides outputs to the operator and receives operator inputs. The user interface includes one or more user input controls 93 and image display 48. User input controls 93 can be provided in the form of a combination of buttons, rocker switches, joysticks, rotary dials, touch screens, and the like. User input controls 93 can include an image capture button, a “zoom in/out” control that controls the zooming of the lens units, and other user controls.

The user interface can include one or more displays or indicators to present camera information to the operator, such as exposure level, exposures remaining, battery state, flash state, and the like. The image display 48 can instead or additionally also be used to display non-image information, such as camera settings. For example, a graphical user interface (GUI) can be provided, including menus presenting option selections and review modes for examining captured images. Both the image display 48 and a digital viewfinder display 76 can provide the same functions and one or the other can be eliminated. The video image capture device 10 can include a speaker, for presenting audio information associated with a video capture and which can provide audio warnings instead of, or in addition to, visual warnings depicted on the status display 74, image display 48, or both. The components of the user interface are connected to the control unit and functions by using a combination of software programs executed on the system controller 66.

The electronic image is ultimately transmitted to the image display 48, which is operated by a display controller 64. Different types of image display 48 can be used. For example, the image display 48 can be a liquid crystal display (LCD), a cathode ray tube display, or an organic electroluminescent display (OLED). The image display 48 is preferably mounted on the camera body so as to be readily viewable by the photographer.

As a part of showing an image on the image display 48, the video image capture device 10 can modify the image for calibration to the particular display. For example, a transform can be provided that modifies each image to accommodate the different capabilities in terms of gray scale, color gamut, and white point of the image display 48 and the image sensor 18 and other components of the electronic image capture unit 14. It is preferred that the image display 48 is selected so as to permit the entire image to be shown; however, more limited displays can be used. In the latter case, the displaying of the image includes a calibration step that cuts out part of the image, or contrast levels, or some other part of the information in the image.

It will also be understood that the video image capture device 10 described herein is not limited to a particular feature set, except as defined by the claims. For example, the video image capture device 10 can be a dedicated video camera or can be a digital camera capable of capturing video sequences, which can include any of a wide variety of features not discussed in detail herein, such as, detachable and interchangeable lenses. The video image capture device 10 can also be portable or fixed in position and can provide one or more other functions related or unrelated to imaging. For example, the video image capture device 10 can be a cell phone camera or can provide communication functions in some other manner. Likewise, the video image capture device 10 can include computer hardware and computerized equipment. The video image capture device 10 can also include multiple electronic image capture units 14.

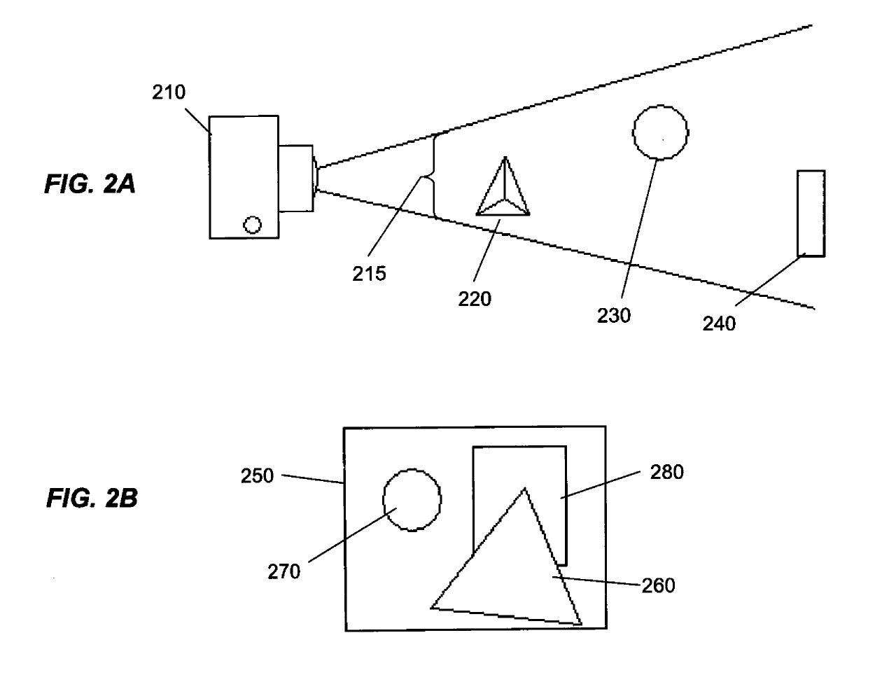

FIG. 2A shows an illustration of a video image capture device 210 and its associated field of view 215, wherein three objects (a pyramid object 220, a ball object 230 and a rectangular block object 240) are located in the field of view 215. The objects are located at different distances from the image capture device. FIG. 2B shows an illustration of a captured image frame 250 of the field of view 215 as captured by the video image capture device 210 from FIG. 2A. Pyramid object position 260, ball object position 270 and rectangular object position 280 indicate the positions of the pyramid object 220, the ball object 230 and the rectangular block object 240, respectively, in the field of view 215 as seen in FIG. 2A.

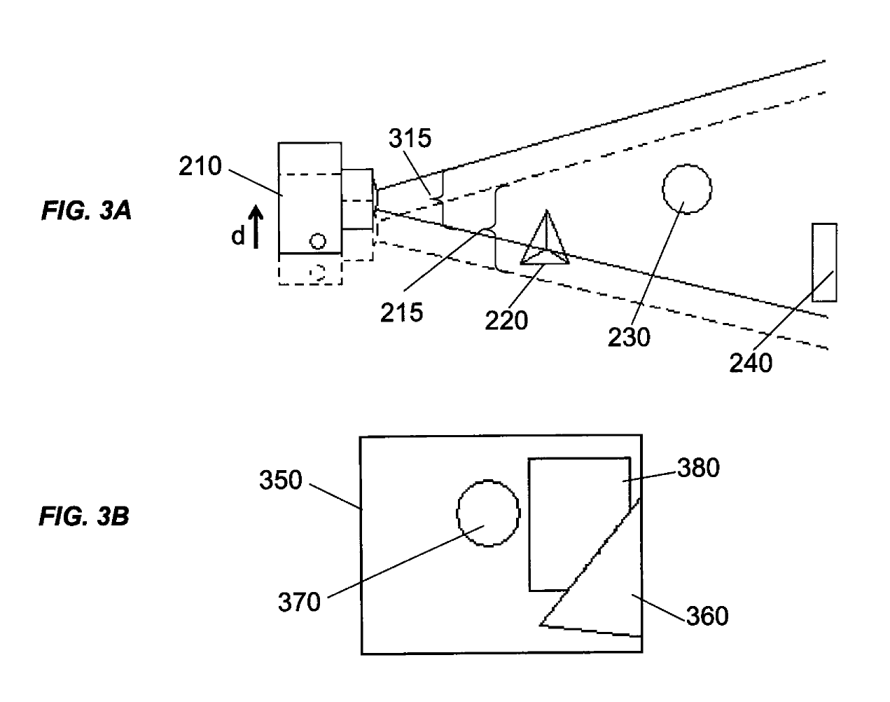

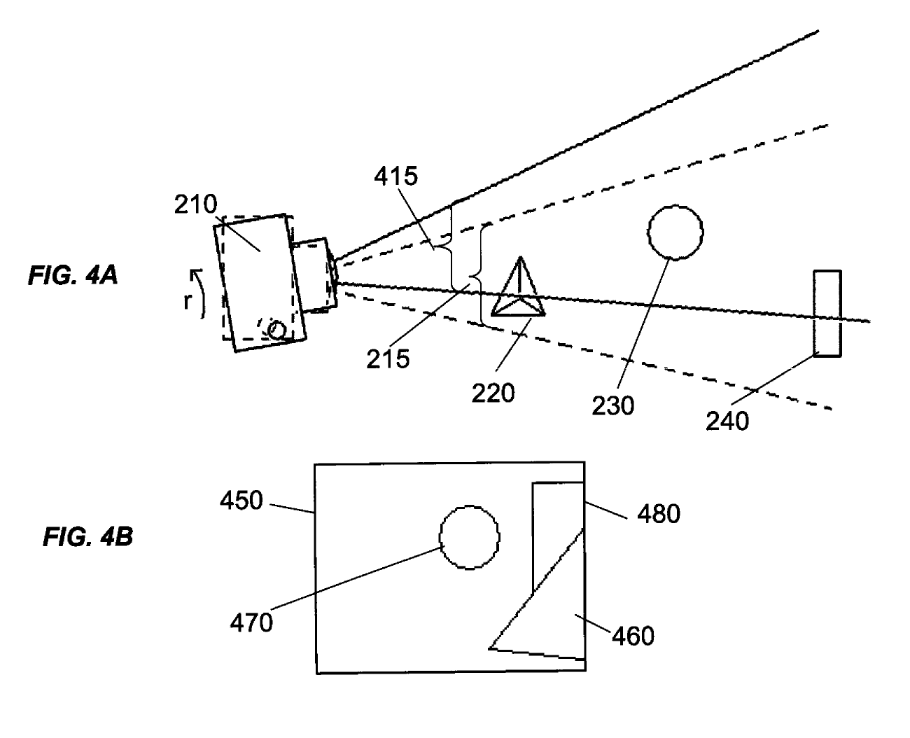

FIGS. 3A and 4A show how the field of view 215 changes as the video image capture device 210 moves between captures. FIG. 3A shows an illustration of a captured image frame 350 corresponding to the change in field of view for a lateral movement, d, of the video image capture device 210 between captures. In this case, the field of view 215 changes to field of view 315, resulting in new object positions (pyramid object position 360, ball object position 370 and rectangular block object position 380) within the captured image frame 350.

While the relative location of the objects (pyramid object 220, ball object 230 and rectangular block object 240) are all shifted laterally by the same distance within the field of view, because the field of view has an angular boundary in the scene, the change in position of the objects in the captured image is affected by the distance of the object from the video image capture device 210. As a result, comparing FIG. 2B to FIG. 3B shows how the positions of the objects in the captured image change for a lateral movement of the image capture device.

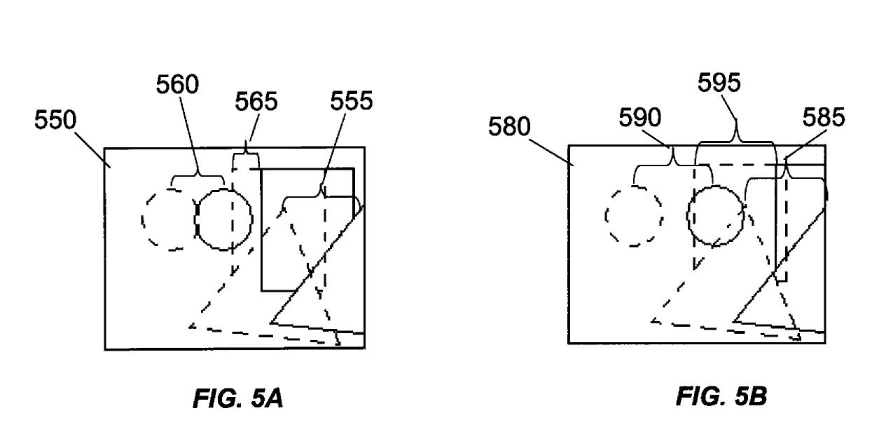

To more clearly visualize the changes in the object positions (known as disparity), FIG. 5A shows an image overlay 550 of the captured image frame 250 from FIG. 2B with the captured image frame 350 from FIG. 3B. The pyramid object 220 has a large pyramid object disparity 555 because it is closest to the video image capture device 210. The rectangular block object 240 has a small rectangular block object disparity 565 because it is the farthest from the video image capture device 210. The ball object 230 has a medium ball object disparity 560 because it has a medium distance from the video image capture device 210.

FIG. 4A shows an illustration of a captured image frame 450 corresponding to the change in field of view for a rotational movement r of the video image capture device 210 between captures. For this rotational movement of the video image capture device 210, the field of view 215 changes to field of view 415. In this case, the objects all move by the same angular amount which shows up in the captured image frame as a lateral movement of all the objects across the image. Comparing FIG. 2B to FIG. 4B shows that the objects are shifted to pyramid object position 460, ball object position 470 and rectangular block object position 480.

To more clearly visualize the changes in the object positions, FIG. 5B shows an image overlay 580 of the captured image frame 250 from FIG. 2B with the captured image frame 450 from FIG. 4B. In this case, the pyramid object 220 has a pyramid object disparity 585, the rectangular block object 240 has a rectangular block object disparity 595, and the ball object 230 has a ball object disparity 590, which are all approximately equal in magnitude.

The presentation of images with different perspectives to the left and right eyes of a viewer to create a perception of depth is well known to those in the art. A variety of methods of presenting stereo pair images to a viewer either simultaneously or in an alternating fashion are available and well known in the art, including: polarization-based displays; lenticular displays; barrier displays; shutter-glasses-based displays; anaglyph displays, and others. Videos with perceived depth formed according to the present invention can be displayed on any of these types of stereoscopic displays. In some embodiments, the video image capture device can include a means for viewing the video with perceived depth directly on the video image capture device. For example, a lenticular array can be disposed over the image display 48 (FIG. 1) to enable direct viewing of the video with perceived depth. As is well known in the art, columns of left and right images in stereo image pairs can then be interleaved and displayed behind a lenticular array such that the left and right stereo images are directed toward the respective left and right eyes of the viewer by the lenticular array to provide stereoscopic image viewing. In an alternate embodiment, the stereo image pairs can be encoded as anaglyph images for direct display on image display 48. In this case, the user can directly view the video with perceived depth using anaglyph glasses having complementary color filters for each eye.

The present invention provides a method for producing a video with perceived depth comprised of stereo pairs by selecting stereo pairs from a video sequence captured with a single-perspective video image capture device 210. A feature of the method is that the video images in each stereo pair be selected from the captured video sequence such that the video images in each stereo pair are separated by a number of video images in the captured video sequence so that the stereo pairs provide the desired difference in perspective to provide perceived depth. The number of video images that separate the video images in the stereo pairs is referred to as the frame offset.

When selecting video images for stereo pairs according to the present invention the movement of the image capture device is considered to determine appropriate frame offsets in order to provide changes in perspective between the video images that will provide desirable perceived depth in the stereo pairs. A lateral movement of the video image capture device 210 during video capture, such as that shown in FIG. 3A, will provide a perception of depth that increases as the lateral movement d or baseline between video images in a stereo pair is increased by increasing the frame offset. In this scenario, the perceived depth for different objects in the field of view will be consistent with the actual distance of the object from the video image capture device 210 as objects that are closer to the image capture device will exhibit more disparity than objects that are farther from the video image capture device 210. (Disparity is sometime referred to as stereo mismatch or parallax.) This variation in disparity with distance for a lateral movement between video images was illustrated in FIG. 5A.

In contrast, a rotational movement of the image capture device during video capture, such as is shown in FIG. 4A, will provide a perceived depth that is not consistent with the actual distance of the object from the image capture device because a pure rotational movement of the image capture device does not provide a new perspective on the scene. Rather, it just provides a different field of view. As a result, objects that are closer to the video image capture device 210 will exhibit the same disparity in a stereo pair as objects that are farther away from the video image capture device 210. This effect can be seen in FIG. 5B which shows an image overlay 580 of the captured image frames 250 and 450 from FIGS. 2B and 4B, respectively. As was noted earlier, the disparities for the different objects are the same for this rotational movement of the image capture device. Since all the objects in the scene have the same disparities, a stereo pair comprised of video images with a frame offset where the image capture device was moved rotationally will not exhibit perceived depth.

Vertical movement of the image capture device between captures of video images does not produce a disparity in a stereo pair that will provide a perception of depth. This effect is due to the fact that the viewer's eyes are separated horizontally. Stereo images pairs that include vertical disparity are uncomfortable to view, and are therefore to be avoided.

In some embodiments, local motion of objects in the scene is also considered when producing a video with perceived depth from a video captured with a video image capture device with a single perspective because the different video images in a stereo pair will have been captured at different times. In some cases, local motion can provide a different perspective on the objects in a scene similar to movement of the image capture device so that a stereo pair comprised of video images where local motion is present can provide a perception of depth. This is particularly true for local motion that occurs laterally.

The invention provides a method for selecting video images within a captured single perspective video to form stereo pairs of video images for a video with perceived depth. The method includes gathering motion tracking information for the image capture device during the capture of the single perspective video to determine the relative position of the image capture device for each video image, along with analysis of the video images after capture to identify motion between video images. By using motion tracking information for the image capture device and analysis of the video images after capture, a variety of motion types can be identified including: lateral motion, vertical motion, rotational motion, local motion and combinations therewith. The speed of motion can also be determined. The invention uses the identified motion type and the speed of the motion to select the frame offset between the video images in the stereo pairs that makeup the video with perceived depth.

For the simplest case of constant lateral speed of movement of the video image capture device 210 during video capture, a constant frame offset can be used in selecting video images for the stereo pairs. For example, to provide a 20 mm baseline between video frames that are selected for a stereo pair, video frames can be identified where the video image capture device 210 has moved a distance of 20 mm. (The baseline is the horizontal offset between the camera positions for a stereo pair.) In a video captured at 30 frames/sec with an image capture device moving at a lateral speed of 100 mm/sec, the frame offset would be 6 frames to provide an approximately 20 mm baseline. For the case where the lateral speed of movement of the video image capture device 210 is varying during a video capture, the frame offset is varied in response to the variations in speed of movement to provide a constant baseline in the stereo pairs. For example if the speed of movement slows to 50 mm/sec, the frame offset is increased to 12 frames and conversely if the speed of movement increases to 200 mm/sec, the frame offset is reduced to 3 frames. In some embodiments, the baseline can be set to correspond to the normal distance between a human observer's eyes in order to provide natural looking stereo images. In other embodiments, the baseline value can be selected by the user to provide a desired degree of perceived depth, where larger baseline values will provide a greater perceived depth and smaller baseline values will provide lesser perceived depth.

For the case of pure vertical movement of the video image capture device 210, a small frame offset (or no frame offset at all) should generally be used in selecting video images for the stereo pairs since vertical disparity will not be perceived as depth, and stereo pairs produced with vertical disparity are uncomfortable to view. In this case, the frame offset can be for example, zero to two frames, where a frame offset of zero indicates that the same video image is used for both video images in the stereo pair and the stereo pair does not provide any perceived depth to the viewer but is more comfortable to view.

In the case of pure rotational movement of the video image capture device 210, a small frame offset should generally be used for reasons similar to the vertical movement case since rotational disparity will not be perceived as depth. In this case the frame offset can be, for example, zero to two frames.

When local motion is present, the frame offset can be selected based on the overall motion (global motion) as determined by the motion tracking of the image capture device, the local motion alone or a combination of the overall motion and local motion. In any case, as the lateral speed of local motion increases, the frame offset is decreased as was described previously for the case of constant lateral speed of movement. Similarly, if the local motion is composed primarily of vertical motion or rotational motion, the frame offset is decreased as well.

The invention uses motion tracking information of the movement of the video image capture device 210 to identify lateral and vertical movement between video images. In some embodiments, the motion tracking information is captured along with the video using a position sensor. For example, this motion tracking information can be gathered with an accelerometer, where the data is provided in terms of acceleration and is converted to speed and position by integration over time. In other embodiments, the motion tracking information can be determined by analyzing the captured video frames to estimate the motion of the video image capture device 210.

Rotational movement of the image capture device during video capture can be determined from motion tracking information collected using a gyroscope or alternately by analysis of the video images. Gyroscopes can provide rotational speed information of an image capture device directly in terms of angular speed. In the case of analyzing video images to determine rotational movement of the image capture device, sequential video images are compared to one another to determine the relative positions of objects in the video images. The relative position of objects in the video images are converted to an image movement speed in terms of pixels/sec by factoring the change in object location with the time between capture of video images from the frame rate. Uniform image movement speed for different objects in the video images is a sign of rotational movement.

Analysis of video images by comparison of object locations in sequential video images can also be used to determine local motion, and lateral or vertical movement of the video image capture device 210. In these cases, the movement of objects between video images is non-uniform. For the case of local motion of objects such as people moving through a scene, the objects will move in different directions and with different image movement speeds. For the case of lateral or vertical movement of the video image capture device 210, the objects will move in the same direction and different image movement speeds depending on how far the objects are from the video image capture device 210.

Table 1 is a summary of the identified motion types from a combination of motion tracking information and the analysis of video images along with the resulting technique that is used to determine the frame offset for the stereo pairs as provided by an embodiment of the invention. As can be seen from the information in Table 1, motion tracking information and analysis of video images are both useful to be able to differentiate between the different types of movement and motion that can be present during video capture or can be present in the scene.

In some embodiments, the video image capture device 210 may not include a position sensor such as an accelerometer. In this case, image analysis can still provide information that is helpful to select the frame offset, but it may not be possible to distinguish between different types of camera motion in some cases. Generally, it will be preferable to use small frame offsets when for cases where there is significant uncertainty in the camera motion type in order to avoid uncomfortable viewing scenarios for the user.

TABLE 1
Identified motion and the resulting
frame offset between stereo pairs

| | Motion From | Camera | |
|---|---|---|---|
| Motion From | Position | Motion | |
| Image Analysis | Sensor | Type | Frame Offset |
| Uniform Lateral | No Motion | Rotational | Small Offset |
| Uniform Lateral | Lateral | Lateral | Based on Sensed Position |
| Vertical | No Motion | Rotational | Small Offset |
| Vertical | Vertical | Vertical | Small Offset |
| Uniform Lateral | Vertical | Vertical | Small Offset |
| Vertical | Lateral | Lateral | Based on Sensed Position |
| Fast | Fast | Fast | Small Offset |
| Fast | Slow | Rotational | Small Offset |
| Slow | Fast | Rotational | Small Offset |
| Vertical & | Lateral | Rotational | Small Offset |
| Lateral | | | |
| Vertical & | Vertical | Rotational | Small Offset |
| Lateral | | | |
| Uniform Lateral | Vertical & | Rotational | Small Offset |
| | Lateral | | |
| Vertical | Vertical & | Rotational | Small Offset |
| | Lateral | | |
| Locally Varying | No Motion | Local | Based on Image Analysis |
| Lateral | | | |
| Locally Varying | Lateral | Lateral & | Based on Image Analysis |
| Lateral | | Local | & Sensed Position |
| Locally Varying | No Motion | Local | Based on Image Analysis |
| Vertical | | | |
| Locally Varying | Lateral | Lateral & | Based on Image Analysis |
| Vertical | | Local | & Sensed Position |
| Locally Varying | Vertical | Vertical & | Small Offset |
| | | Local | |

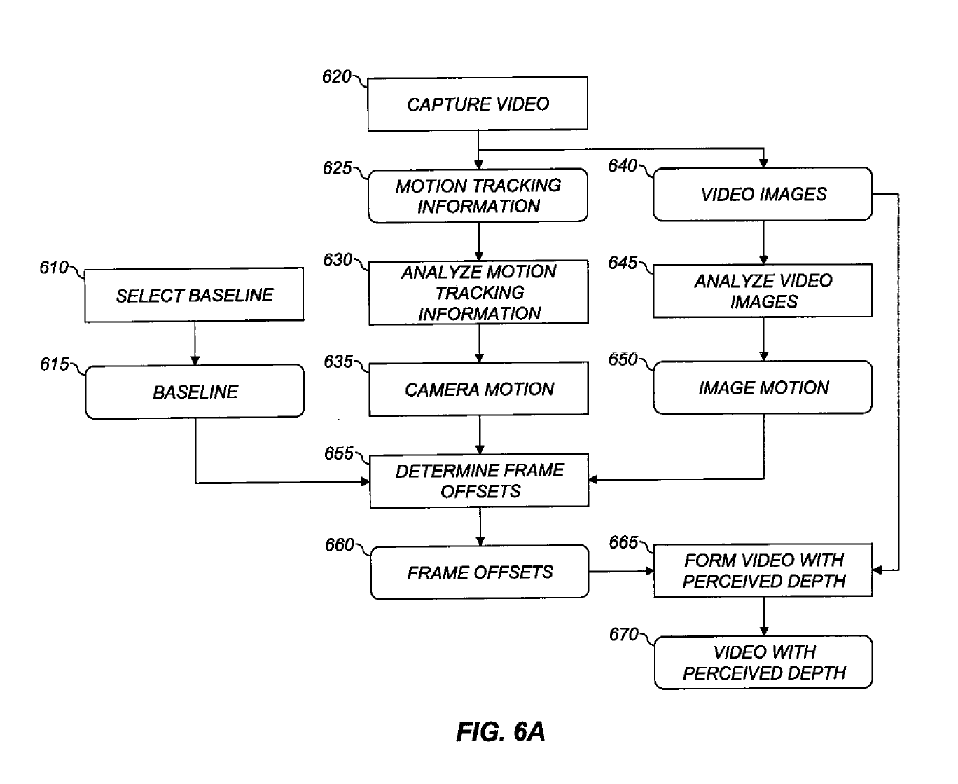

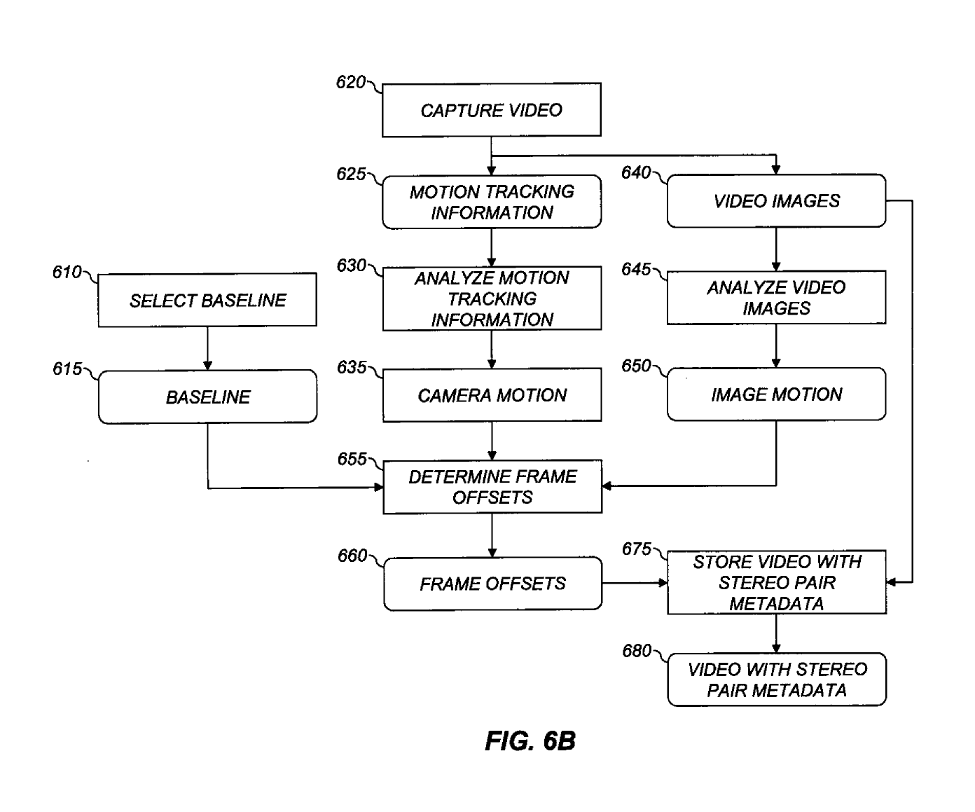

FIG. 6A is a flowchart of a method for forming a video with perceived depth according to one embodiment of the present invention. In a select baseline step 610, a baseline 615 is selected by the user that will provide the desired degree of depth perception in the stereo pairs. The baseline 615 is in the form of a lateral offset distance between video images in the stereo pairs or in the form of a pixel offset between objects in video images in the stereo pairs.

In capture video step 620, a sequence of video images 640 is captured with a single perspective video image capture device. In a preferred embodiment, motion tracking information 625 is also captured using a position sensor in a synchronized form along with the video images 640.

In analyze motion tracking information step 630, the motion tracking information 625 is analyzed to characterize camera motion 635 during the video capture process. In some embodiments, the camera motion 635 is a representation of the type and speed of movement of the video image capture device.

In analyze video images step 645, the video images 640 are analyzed and compared to one another to characterize image motion 650 in the scene. The image motion 650 is a representation of the type of image movement and the image movement speeds, and can include both global image motion and local image motion.

The comparison of the video images can be done by correlating the relative location of corresponding objects in the video images on a pixel by pixel basis or on a block by block basis. Where a pixel by pixel correlation provides more accurate image movement speeds but is slow and requires high computational power and a block by block correlation provides a less accurate measure of movement speeds but requires less computational power and is faster.

A very efficient method of comparing video images to determine the type of movement and speed of image movement can also be done by leveraging calculations associated with the MPEG video encoding scheme. MPEG is a popular standard for encoding compressed video data and relies on the use of I-frames, P-frames, and B-frames. The I-frames are intra coded, i.e. they can be reconstructed without any reference to other frames. The P-frames are forward predicted from the last I-frame or P-frame, i.e. it is impossible to reconstruct them without the data of another frame (I or P). The B-frames are both, forward predicted and backward predicted from the last/next I-frame or P-frame, i.e. there are two other frames necessary to reconstruct them. P-frames and B-frames are referred to as inter coded frames.

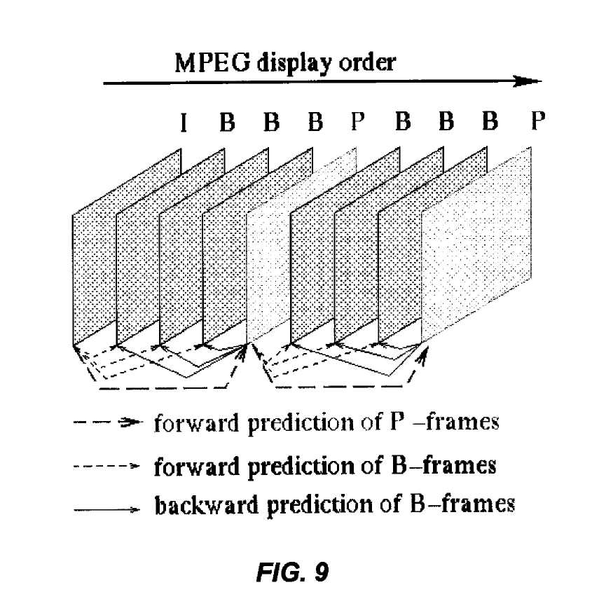

FIG. 9 shows an example of an MPEG encoded frame sequence. The P-frames and B-frames have block motion vectors associated with them that allows the MPEG decoder to reconstruct the frame using the I-frames as the starting point. In MPEG-1 and MPEG-2, these block motion vectors are computed on 16×16 pixel blocks (referred to as macro-blocks) and represented as horizontal and vertical motion components. If the motion within the macro-block is contradictory, the P-frame and B-frames can also intra code the actual scene content instead of the block motion vector. In MPEG-4, the macro blocks can be of varying size and not restricted to 16×16 pixels.

In a preferred embodiment, the block motion vectors associated with the MPEG P- and B-frames can be used to determine both the global image motion and the local image motion in the video sequence. The global image motion will typically be associated with the motion of the video image capture device 210. The global image motion associated with the video image capture device 210 as determined either from the P- and B-frames (or alternately as determined from the motion tracking information 625) can be subtracted from the MPEG motion vectors to provide an estimate of the local image motion.

Next, a determine frame offsets step 655 is used to determine frame offsets 660 to be used to form stereo image pairs responsive to the determined camera motion 635 and image motion 650, together with the baseline 615. In a preferred embodiment, the type of movement and the speed of movement for the camera motion 635 and the image motion 650 are used along with Table 1 to determine the frame offset to be used for each video image in the captured video. For example, if the motion from position sensor (camera motion 635) is determined to correspond to lateral motion and the motion from image analysis (image motion 650) is determined to be uniform lateral motion, then it can be concluded that the camera motion type is lateral and the frame offset can be determined based on the sensed position from the position sensor.

In some embodiments, the frame offset ΔN_{f} is determined by identifying the frames where the lateral position of the camera has shifted by the baseline 615. In other embodiments, the lateral velocity, Vₓ is determined for a particular frame, and the frame offset is determined accordingly. In this case, the time difference Δt between the frames to be selected can be determined from the baseline Δx_{b} by the equation:

Δt=Δx_{b}/Vₓ (1)

The frame offset ΔN_{f} can then be determined from the frame rate R_{f} using the equation:

ΔN_{f}=R_{f}Δt=R_{f}Δx_{b}/Vₓ (2)

Next, a video with perceived depth 670 is formed using a form video with perceived depth step 665. The video with perceived depth 670 includes a sequence of stereo video frames, each being comprised of a stereo image pair. A stereo image pair for i^{th} stereo video frame S(i) can then be formed by pairing the i^{th} video frame F(i) with the video frame separated by the frame offset F(i+ΔN_{f}). Preferably, if the camera is moving to the right, then the i^{th} frame should be used as the left image in the stereo pair; if the camera is moving to the left, then the i^{th} frame should be used as the right image in the stereo pair. The video with perceived depth 670 can then be stored in a stereo digital video file using any method known to those in the art. The stored video with perceived depth 670 can the be viewed by a user using any stereo image display technique known in the art, such as those that were reviewed earlier (e.g., polarization-based displays coupled with eye glasses having orthogonal polarized filters for the left and right eyes; lenticular displays; barrier displays; shutter-glasses-based displays and anaglyph displays coupled with eye glasses having complementary color filters for the left and right eyes).

An alternate embodiment of the present invention is shown in FIG. 6B. In this case, the frame offsets 660 are determined using the same steps that were described relative to FIG. 6A. In this case, however, rather than forming and storing the video with perceived depth 670, a store video with stereo pair metadata step 675 is used to store information that can be used to form the video with perceived depth at a later time. This step stores the captured video images 640, together with metadata indicating what video frames should be used for the stereo pairs, forming a video with stereo pair metadata 680. In some embodiments, the stereo pair metadata stored with the video is simply the determined frame offsets for each video frame. The frame offset for a particular video frame can be stored as a metadata tag associated with the video frame. Alternately, the frame offset metadata can be stored in a separate metadata file associated with the video file. When it is desired to display the video with perceived depth, the frame offset metadata can be used to identify the companion video frame that should be used to form the stereo image pair. In alternate embodiments, the stereo pair metadata can be frame numbers, or other appropriate frame identifiers, rather than frame offsets.

The method shown in FIG. 6B has the advantage that it reduces the file size of the video file relative to the FIG. 6A embodiment, while preserving the ability to provide a 3-D video with perceived depth. The video file can also be viewed on a conventional 2-D video display without the need to perform any format conversion. Because the file size of the frame offsets is relatively small, the frame offset data can be stored with the metadata for the captured video.

Typically, a position sensor 79 (FIG. 1) is used to provide the motion tracking information 625 (FIG. 6A). In some embodiments of the present invention, the position sensor 79 can be provided by a removable memory card that includes one or more accelerometers or gyroscopes along with stereoscopic conversion software to provide position information or motion tracking information to the video image capture device 210. This approach makes it possible to provide the position sensor as an optional accessory to keep the base cost of the video image capture device 210 as low as possible, while still enabling the video image capture device 210 to be used for producing videos with perceived depth as described as a previous embodiment of the invention. The removable memory card can be used as a replacement for the memory card 72c in FIG. 1. In some embodiments, the removable memory card simply serves as a position sensor and provides position data or some other form of motion tracking information to a processor in the video image capture device 210. In other configurations, the removable memory card can also include a processor, together with appropriate software, for forming the video with perceived depth.

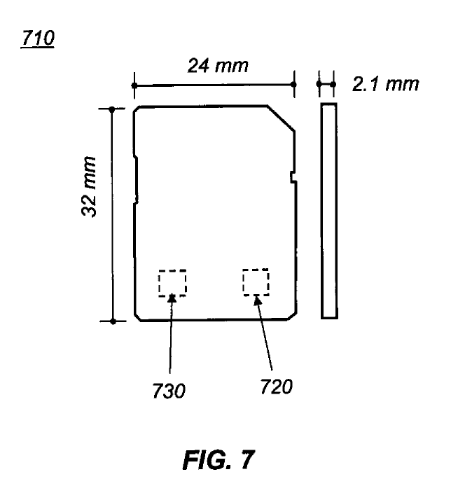

FIG. 7 is an illustration of a removable memory card 710 with built-in motion tracking devices. Motion tracking devices that are suitable for this use are available from ST Micro in the form of a 3 axis accelerometer that is 3.0×5.0×0.9 mm in size and a 3 axis gyroscope that is 4.4×7.5×1.1 mm in size. FIG. 7 shows the relative size of an SD removable memory card 710 and the above mentioned 3-axis gyroscope 720 and 3-axis accelerometer 730.

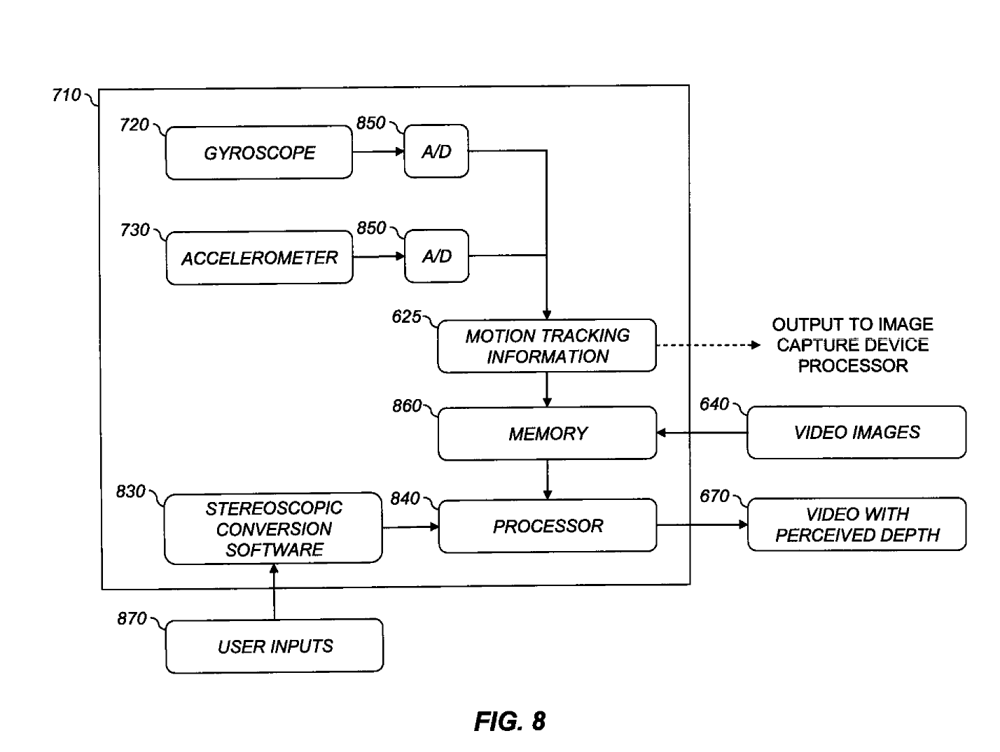

FIG. 8 shows a block diagram of a removable memory card 710 with built-in motion tracking devices that includes the components needed to form video images with perceived depth inside the card removable memory card. As described with reference to FIG. 7, the removable memory card 710 includes a gyroscope 720 and an accelerometer 730, that capture the motion tracking information 625. One or more analog-to-digital (A/D) converters 850 are used to digitize the signals from the gyroscope 720 and the accelerometer 730. The motion tracking information 625 can optionally be sent directly to the processor of the video image capture device 210 for use in forming video images with perceived depth, or for other applications. Video images 640 captured by the video image capture device 210 are stored in memory 860 in a synchronized fashion with the motion tracking information 625.

Stereoscopic conversion software 830 for implementing the conversion of the captured video images 640 to form a video with perceived depth 670 through the steps of the flowcharts in FIG. 6A or 6B can also be stored in the memory 860 or in some other form of storage such as an ASIC. In some embodiments, portions of the memory 860 can be shared between the removable memory card 710 and other memories on the video image capture device. In some embodiments, the stereoscopic conversion software 830 accepts user inputs 870 to select between various modes for producing videos with perceived depth and for specifying various options such as the baseline 615. Generally, the user inputs 870 can be supplied through the user input controls 93 for the video image capture device 10 as shown in FIG. 1. The stereoscopic conversion software 830 uses a processor 840 to process the stored video images 640 and motion tracking information 625 to produce the video with perceived depth 670. The processor 840 can be inside the removable memory card 710, or alternately can be a processor inside the video image capture device. The video with perceived depth 670 can be stored in memory 860, or can be stored in some other memory on the video image capture device or on a host computer.

In some embodiments, the position sensor 79 can be provided as an external position sensing accessory which communicates with the video image capture device 210 using a wired or wireless connection. For example, the external position sensing accessory can be a dongle containing a global positioning system receiver which can be connected to the video image capture device 210 using a USB or a Bluetooth connection. The external position sensing accessory can include software for processing a received signal and communicating with the video image capture device 210. The external position sensing accessory can also include the stereoscopic conversion software 830 for implementing the conversion of the captured video images 640 to form a video with perceived depth 670 through the steps of the flowcharts in FIG. 6A or 6B.

In some embodiments, image processing can be used to adjust one or both of the video frames in a stereo image pair in the form video with perceived depth step 665 to provide an improved viewing experience. For example, if it is detected that the video image capture device 210 was moved vertically or was tilted between the times that the two video frames were captured, one or both of the video frames can be shifted vertically or rotated to better align the video frames. The motion tracking information 625 can be used to determine the appropriate amount of shift and rotation. In cases where shifts or rotations are applied to the video frames, it will generally be desirable to crop the video frames so that the shifted/rotated image fills the frame.

The invention has been described in detail with particular reference to certain preferred embodiments thereof, but it will be understood that variations and modifications can be effected within the spirit and scope of the invention.

### PARTS LIST

10 Video image capture device
14 Electronic image capture unit
16 Lens
18 Image sensor
20 Optical path
22 Shutter
24 Timing generator
26 Filter assembly
28 Aperture
44 Optical system
48 Image display
50 Zoom control
52 Macro control
54 Focus control
56 Rangefinder
58 Brightness sensor
60 Flash system
61 Flash
62 Flash sensor
63 Flash control
64 Display controller
65 Control unit
66 System controller
68 Analog signal processor
70 Digital signal processor
72a Digital signal processor (DSP) memory
72b System memory
72c Memory card
72d Program memory
74 Status display
76 Viewfinder display
78 Orientation sensor
79 Position sensor
80 Analog to digital (A/D) converter
81 Data bus
82 Socket
83 Memory card interface
84 Host interface
86 Video encoder
93 User input controls
210 Video image capture device
215 Field of view
220 Pyramid object
230 Ball object
240 Rectangular block object
250 Captured image frame
260 Pyramid object position
270 Ball object position
280 Rectangular block object position
315 Field of view
350 Captured image frame
360 Pyramid object position
370 Ball object position
380 Rectangular block object position
415 Field of view
450 Captured image frame
460 Pyramid object position
470 Ball object position
480 Rectangular block object position
550 Image overlay
555 Pyramid object disparity
560 Ball object disparity
565 Rectangular block object disparity
580 Image overlay
585 Pyramid object disparity
590 Ball object disparity
595 Rectangular block object disparity
610 Select baseline step
615 Baseline
620 Capture video step
625 Motion tracking information
630 Analyze motion tracking information step
635 Camera motion step
640 Video images
645 Analyze video images step
650 Image motion
655 Determine frame offsets step
660 Frame offsets
665 Form video with perceived depth step
670 Video with perceived depth
675 Store video with stereo pair metadata step
680 Video with stereo pair metadata
710 Removable memory card
720 Gyroscope
730 Accelerometer
830 Stereoscopic conversion software
840 Processor
850 Analog-to-digital (A/D) converter
860 Memory
870 User inputs

1. A video image capture device for providing a video with perceived depth comprising:
an image sensor for capturing video frames;
an optical system for imaging a scene onto the image sensor from a single perspective;
a data storage system for storing a sequence of video images captured by the image sensor;
a position sensing device for sensing a relative position of the image capture device for the sequence of video images;
a means for storing an indication of the sensed relative position of the image capture device on the data storage system in association with stored sequences of video images;
a data processor;
a memory system communicatively connected to the data processor and storing instructions configured to cause the data processor to provide a video with perceived depth by:
selecting stereo pairs of video images responsive to the stored relative position of the image capture device; and
providing a video with perceived depth using a sequence of the stereo pairs of video images.

2. The video image capture device of claim 1 wherein the position sensing device includes an accelerometer, a gyroscopic device or a global positioning system device.

3. The video image capture device of claim 1 wherein the position sensing device is removable from the video image capture device.

4. The video image capture device of claim 3 wherein the removable position sensing device is formatted to fit within a removable memory card receptacle.

5. The video image capture device of claim 3 wherein the removable motion tracking device further includes the memory system storing instructions configured to cause the data processor to provide the video with perceived depth.

6. The video image capture device of claim 1 wherein the position sensing device is external to the video image capture device and communicates with the video image capture device using a wired or wireless connection.

7. The video image capture device of claim 1 wherein the stereo pairs of video images are selected by identifying pairs of video images where the sensed relative position of the image capture device has changed by a specified distance.

8. The video image capture device of claim 7 wherein the specified distance is a distance in a horizontal direction.

9. The video image capture device of claim 7 wherein the specified distance is reduced when the sensed relative position of the image capture device indicates motion of the image capture device in a vertical direction or a rotational direction.

10. The video image capture device of claim 7 wherein the specified distance is reduced to zero when the sensed relative position of the image capture device indicates motion of the image capture device that is outside of a defined range.

11. The video image capture device of claim 1 wherein the instructions configured to cause the data processor to provide a video with perceived depth further includes analyzing the captured sequence of video images to determine the movement of objects in the scene, and wherein the selection of the stereo pairs of video images is further responsive to the determined object movements.

12. The video image capture device of claim 11 wherein the movement of objects in the scene is determined by correlating the relative position of corresponding objects in the captured sequence of video images.

13. The video image capture device of claim 11 wherein the selection of the stereo pairs of video images includes:
determining frame offsets for the stereo pairs of video images responsive to the stored relative position of the video image capture device;
reducing the frame offsets when the object movement is determined to be outside of a defined range; and
selecting stereo pairs of video images using the reduced frame offsets.

14. The video image capture device of claim 13 wherein the frame offsets are reduced to zero when the amount of object movement is outside of a defined range.

15. The video image capture device of claim 1 wherein the video with perceived depth is provided by storing an indication of frame offsets between the stereo pairs of video images in association with the stored sequence of video images.

16. The video image capture device of claim 15 wherein the indication of frame offsets is stored as metadata in a digital video file used to store the captured sequence of video images.

17. The video image capture device of claim 15 wherein the indication of the frame offsets is stored in a digital metadata file, and wherein the digital metadata file is associated with a digital video file used to store the captured sequence of video images.

18. The video image capture device of claim 1 wherein the video with perceived depth is provided by storing stereo pairs of images for each video frame.

19. The video image capture device of claim 1 wherein the video with perceived depth is provided by storing anaglyph images appropriate for viewing with eye glasses having complementary color filters for left and right eyes.

20. The video image capture device of claim 19 further including:
a color image display, and
means for displaying the anaglyph images on the color image display.

21. The video image capture device of claim 1 further including:
an image display having a lenticular array disposed thereon for stereoscopic image viewing; and
means for displaying the video with perceived depth on the image display.
